(19) United States
(12) Patent Application Publication
(10) Pub. No.: US 2009/0079851 A1
(43) Pub. Date: Mar. 26, 2009

(54) Video signal compensation circuit assembly

(75) Inventor: David Hsu, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: C&C TECHNIC TAIWAN CO., LTD., Taipei Hsien (TW)

(21) Appl. No.: 11/902,230

(22) Filed: Sep. 20, 2007

(51) Int. Cl. H04N 5/217

(52) U.S. Cl. 348/241; 348/E05.078

(57) ABSTRACT

A video signal compensation circuit assembly is disclosed to include a video signal compensator electrically connected to a computer through a standard VGA cable to compensate for the video signal outputted from the computer, a video signal amplifier electrically connected in series between the video signal compensator and a display monitor for amplifying the compensated video signal outputted from the video signal compensator for display through the display monitor, and a synchronous signal processor electrically connected in parallel to the output end of the video signal compensator to make correction of the video signal outputted from the computer into the video signal compensator.

### BACKGROUND OF THE INVENTION

1. Field of the Invention

The present invention relates to a video signal compensation means and more particularly, to a video signal compensation circuit assembly, which processes the outputted video signal from a computer through compensation, amplification and correction processing processes, maintaining the original video signal architecture and improving the image quality, eliminating the problem of image distortion due to long transmission through the VGA cable.

2. Description of the Related Art

For long distance video signal transmission from a computer to a display monitor, a standard VGA cable is commonly used. However, the video signal architecture may be changed after a long distance transmission through a standard VGA cable, resulting in a poor image quality. It is the common way to eliminate this problem by means of lowering the image resolution. However, lowering the resolution relatively lowers the image quality.

Therefore, it is desirable to provide video signal compensation means that eliminates the aforesaid problems.

### SUMMARY OF THE INVENTION

The present invention has been accomplished under the circumstances in view. It is therefore the main object of the present invention to provide a video signal compensation circuit assembly, which processes the outputted video signal from a computer through compensation, amplification and correction processing processes, maintaining the original video signal architecture and improving the image quality, eliminating the problem of image distortion due to long transmission through the VGA cable.

To achieve this and other objects of the present invention, the video signal compensation circuit assembly comprises a video signal compensator electrically connected to a computer through a standard VGA cable to compensate for the video signal outputted from the computer, a video signal amplifier electrically connected in series between the video signal compensator and a display monitor for amplifying the compensated video signal outputted from the video signal compensator for display through the display monitor, and a synchronous signal processor electrically connected in parallel to the output end of the video signal compensator to make correction of the video signal outputted from the computer into the video signal compensator.

### BRIEF DESCRIPTION OF THE DRAWINGS

FIG. 1 is a circuit block diagram of the present invention.

FIG. 2 is an applied view of the present invention.

### DETAILED DESCRIPTION OF THE PREFERRED EMBODIMENT

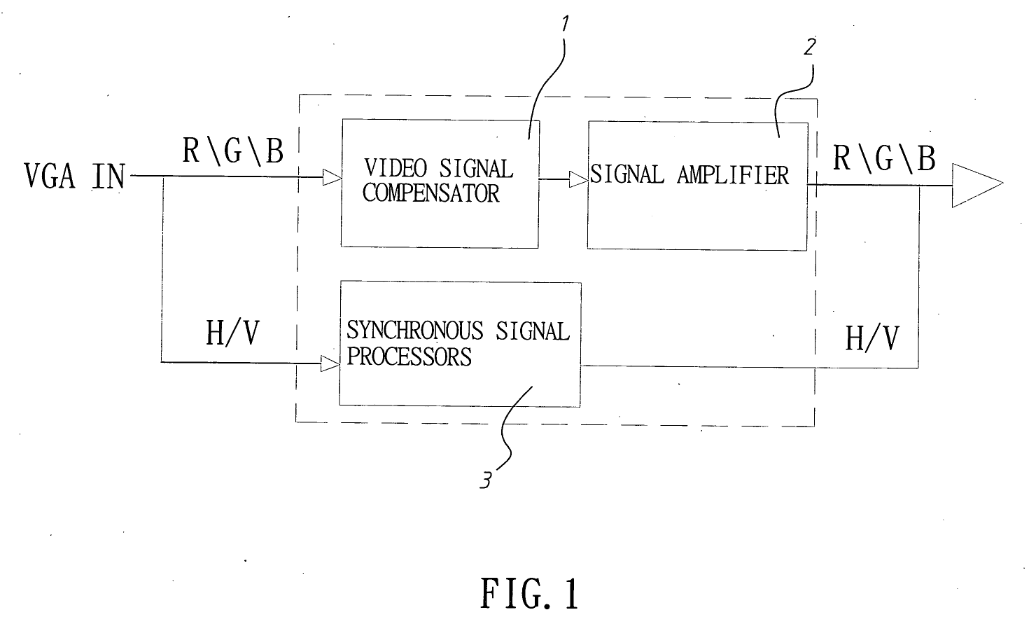

Referring to FIG. 1, a video signal compensation circuit assembly in accordance with the present invention is shown comprised of a video signal compensator 1, a video signal amplifier 2, and a synchronous signal processor 3.

The video signal compensator 1 is electrically connected to a computer or the like through a standard VGA cable to receive output video signal from the display card of the computer. The video signal amplifier 2 has its input end electrically connected to the video signal compensator 1 and its output end electrically connected to a display monitor. The synchronous signal processor 3 is connected in parallel to the input end of the video signal compensator 1.

The video signal compensator 1 compensates the output video signal from the computer for amplification by the video signal amplifier 2, and the amplified video signal is processed through the synchronous signal processor 3 and then outputted to the display monitor for display. After compensation, amplification and correction through the video signal compensation circuit assembly, the original video signal architecture is maintained, and the image quality is improved, eliminating the problem of image distortion due to long transmission through the VGA cable.

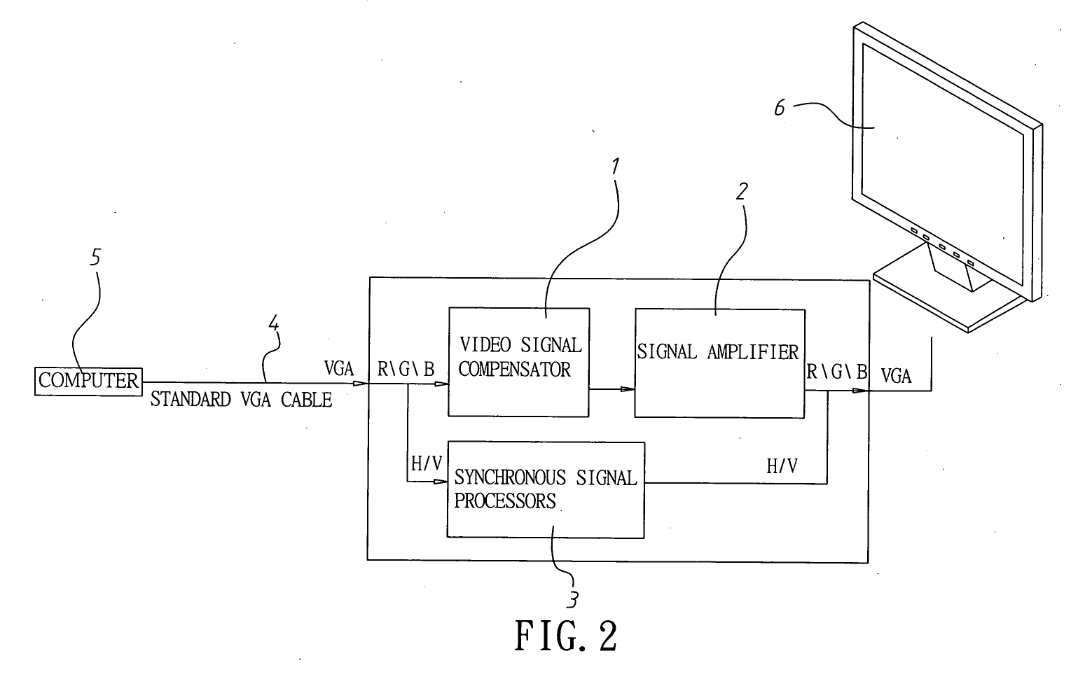

Referring to FIG. 2, during application of the present invention, the video signal compensator 1 is electrically connected to a computer (or the like) 5 through a standard VGA cable 4 to compensate for the video signal and synchronizing signal outputted from the display card of the computer. The signal amplifier 2 amplifies the signal outputted from the video signal compensator 1. The synchronous signal processor 3 processes the amplified signal outputted from the signal amplifier 2, making the necessary correction. The processed video signal is then outputted from the synchronous signal processor 3 to a display monitor 6 for display.

As stated above, the video signal compensation circuit assembly of the present invention processes the outputted video signal from a computer through compensation, amplification and correction processing processes, maintaining the original video signal architecture and improving the image quality, eliminating the problem of image distortion due to long transmission through the VGA cable.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A video signal compensation circuit assembly, comprising:
a video signal compensator having a video signal input end electrically connected to a computer through a standard VGA cable to receive video signal from said computer and to compensate for the video signal;
a video signal amplifier electrically connected in series between a video signal output end of said video signal compensator and a video signal input end of a display monitor and adapted to amplify the video signal compensated by said video signal compensator and to output the amplified video signal to the display monitor connected thereto for display; and
a synchronous signal processor electrically connected in parallel to the output end of said video signal compensator to make correction of the video signal outputted from the computer into said video signal compensator.
